(19) United States
(12) Patent Application Publication
(10) Pub. No.: US 2007/0116241 A1
(43) Pub. Date: May 24, 2007

(54) Support case management system

(76) Inventors: Phil A. Flocken, Denver, CO (US); William Brothers, Rocklin, CA (US); Yassine Faihe, Grenoble (FR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/271,586

(22) Filed: Nov. 10, 2005

(51) Int. Cl. H04M 3/00; H04M 5/00

(52) U.S. Cl. 379/265.05

(57) ABSTRACT

A method embodiment for assigning support in a customer support system comprising receiving a support request, identifying evaluation criteria corresponding to the request based upon a predetermined set of criteria types, comparing the evaluation criteria with support profiles of a plurality of support engineers, identifying a selected support engineer based upon the results of the comparison, and assigning the request to the selected support engineer.

### BACKGROUND

Advances in technology have resulted in conveniences that prior generations never imagined. Items such as cell phones, portable computers, personal digital assistants (PDAs) can be seen most anywhere. Many new automobiles are manufactured with global positioning satellite (GPS) systems. The internet has provided a plethora of new conveniences. On-line access to bank accounts and credit card accounts are revolutionizing the finance industry. Shopping on-line has become a commonplace convenience for millions. All of these high tech systems have changed daily life from that which existed a number of years ago.

One item, however, that necessarily accompanies the use of so many high tech systems is that service and repair issues will undoubtedly arise. As more systems are introduced and more people use such systems, the volume of repair or service issues increases. Additionally, as the complexity of systems increases (e.g., a standard cellular phone today typically has a high number of features), customer questions on how to operate the various systems also increases.

Current methods of handling service requests vary greatly from company to company and industry to industry, but all typically contain shortcomings in the speed and efficiency with which such requests are processed. One common complaint with many customer service branches is experiencing extended hold times before reaching a customer service representative. Furthermore, often once a customer does get through, the individual with whom he or she is connected is not the appropriate person to handle the request. In such case, it is not uncommon for a customer to be transferred to another representative, in some cases several times, to have their question answered or their request for service handled. Such experiences often lead to customer dissatisfaction.

### BRIEF DESCRIPTION OF THE DRAWINGS

For the purpose of illustrating the invention, there is shown in the drawings one exemplary implementation; however, it is understood that this invention is not limited to the precise arrangements and instrumentalities shown.

FIG. 1 is block diagram of a support case management system in accordance with an exemplary embodiment of the present invention.

FIG. 2 is a flow chart of a method of processing requests for support in accordance with an exemplary embodiment of the present invention.

FIG. 3 is a flow chart of a method of assigning a support engineer in accordance with an exemplary embodiment of the present invention.

### DETAILED DESCRIPTION

Overview

Most customer support systems in use today typically operate by having a requester, such as a customer contact a customer service representative. This is often done via telephone, whereby the customer calls a service number and speaks to the next available service representative. Other manners of contacting the service representative include sending an email to a service email address for the system or leaving a voice phone message. In all of these methods, the customer's service request is eventually provided to a customer service representative who evaluates the request and directs it appropriately.

Handling customer service requests in this fashion creates several inefficiencies. Most phone systems place incoming calls into a queue, from which calls are typically answered in the order in which they are received. The representative who eventually answers the call may or may not be the correct individual to process the request. If the call needs to be handled by a different department, the customer is transferred and the process begins again.

Additionally, there is currently no mechanism for ensuring that two customer service representatives are not addressing similar or even identical problems. System efficiency would be greatly enhanced by a mechanism to allow for selectively choosing a service representative in manner that would allow for service representatives to benefit from the experiences of other representatives who may have handled similar issues. The system in accordance with an exemplary embodiment of the present invention provides such a mechanism. At the same time, the system described herein further provides a means to efficiently utilize skills or expertise of certain representatives, skills that may not be common to all representatives.

Support Management System

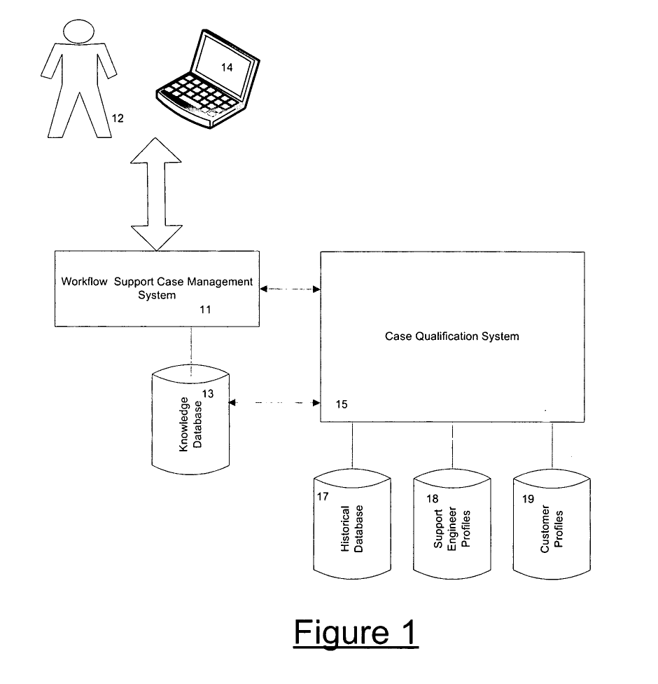

A block diagram of a support management system in accordance with an exemplary embodiment of the present invention is shown in FIG. 1. Referring to FIG. 1, the various components of an exemplary system for selectively assigning a support engineer are illustrated. Following the description of each component contained in the system, the function of the system as a whole is described in detail below.

In an exemplary embodiment, a support case management module 11 receives the service request from a customer 12. The support case management module 11 typically contains an input mechanism such as a graphical user interface (GUI) 14 provided via a web portal. Use of a GUI interface 14 allows for the customer 12 to enter sufficient details to permit proper evaluation of the service request in order to rout the request to the appropriate support engineer. For example, various customer input fields can be provided to set out the environment in which the customer is operating. The fields requested can be tailored to correspond to criteria that will be used to classify the service request. For example, the customer can be requested to input the type of hardware he or she is using, the type of operating system, or other information that might be deemed helpful to evaluating the service request. The input data fields are configured to obtain data that is beneficial to a particular application that the system is supporting. Additionally, optional text fields can be provided whereby the customer 12 can describe the service request. Keyword searching on such text input will further aid service request classification.

Alternative input mechanisms can be employed to provide a service request to the support case management module 11. For example, a live agent can be provided to speak to the customer and collect the appropriate information which can then be submitted to the support case management module 11. Alternatively, an automated telephone system with appropriate prompts and/or voice recognition capabilities can be used to collect the appropriate information.

Once the support request has been received by the support case management module 11, a determination can be made on the appropriate processing. Initially, the system provides customer access to a knowledge database 13. In an exemplary embodiment, the knowledge database 13 is accessible directly to the customer via the GUI interface. The knowledge database 13 contains complete information regarding prior support requests, including previously processed support requests, information used to solve the request (e.g., hardware involved, platform, etc.), and solution data. A comparison can be made between the newly received support request with previously processed support requests stored in the knowledge database 13. The comparison can be based upon various criteria set by a system administrator. Typically, the comparison is performed using a search engine, many of which are known in the art, to search the various identified criteria. For example, keywords can be identified in the received support request and compared to stored keywords associated with the support requests stored in the knowledge database 13. If the current support request exceeds a predetermined threshold of likeness with one or more stored support requests (e.g., the stored support requests are sufficiently similar to the current request such that the solution associated with the stored support request is likely to provide the solution to the current request), the matching stored solutions are retrieved from the knowledge database 13. These solutions can be automatically displayed to the customer as text descriptions. If the customer achieves satisfactory results with the solution(s) provided, there is no need for support engineer involvement.

However, if a search of prior support cases does not yield an acceptable solution, the service request can be assigned to a support engineer for further processing. Following the assigning of an engineer, the knowledge database used to determine if an engineer was desired can also be used as a resource for the engineer. In the exemplary embodiment, some data in the knowledge database base 13 is reserved to be viewed only by engineers, and would not be visible to customers. For example, a solution in the knowledge base 13 might have been authored by a particular engineer (upon the first occurrence of a problem) and refined or modified by subsequent engineers. Typically, the prior versions would not be viewable to the customer, as the customer would only be returned the final version of the solution.

Selection of an appropriate support engineer can be accomplished using a case qualification module 15. The case qualification module 15 typically evaluates the current support request in order to determine the most efficient means for processing task of assigning the request to a support engineer. In the exemplary system illustrated in FIG. 1, a series of databases are used to store qualification data. The service request can be evaluated using the data from the various databases and classified accordingly. For example, a historical database 17 stores prior service requests and their associated solutions. Further, it might be beneficial to assign a request involving a printer issue in an Information Technology (IT) support system to a support engineer that has prior experience with printer issues. Thus, a comparison of the current support request with the solutions in the historical database 17 can provide a set of support engineers with prior experience in the area of the request. In addition, the solutions stored in the database can serve as a resource after an engineer has been assigned. The support engineer can access the historical database 17 as a reference to view prior solutions from similar areas or to obtain the names of other engineers who have handled similar requests so that he or she can be contacted for assistance if desired.

A customer profiles database 19 stores information relating to the operating environment of a customer (e.g., hardware in use by customer, operating system, etc.). The customer profile may be stored by customer name, which can be readily searched. If the customer has a profile stored in the Customer Profiles database 19, the profile can be retrieved. The information stored in the retrieved profile can be used to provide additional context by which a support engineer can be selected. If no profile exists for a particular customer 12, a request can be made to the customer via the GUI interface 14 for additional information to complete a full profile. In the exemplary embodiment, however, this additional information gathering would be performed by the support engineer following assignment of the service request, as needed. This avoids potential delay that could be incurred by gathering information that could be unnecessary.

A support engineer profiles database 18 stores information on expertise of the various support engineers. For example, a particular support request may involve a technical aspect (e.g., a computer language such as Java). Various support engineers may have varying levels of expertise in the required aspect. A hierarchy of desired support engineers can be determined by matching the identifying criteria (e.g., keywords) with the skills of the various support engineers as stored in each engineer's profile in the support engineer profiles database 18.

Additionally, information regarding the availability of all support engineers can be stored in the support engineer profiles database 18. For example, regular work hours for each support engineer can vary, as engineers might maintain different work schedules and might also be located in different time zones worldwide. Hours of availability can be stored for each engineer in the support engineer profiles database 18. Furthermore, an indicator of workload status can be stored in the support engineer profiles database. For example, a counter can be used to indicate the number of service requests currently assigned to a particular engineer. The system can be configured to avoid overloading any one particular engineer (e.g., a particular number of assigned service requests might cause an engineer to be removed from the engineer list available for service request assignment). Various embodiments can also include a more detailed evaluation of availability that includes an estimated time requirement instead of simply an indicator of the number of service requests assigned to a particular engineer. For example, a time estimation indicator might be computed by having certain types of service requests allotted a particular time for service, or alternatively, by allowing a support engineer to estimate time for service upon assignment of a service request.

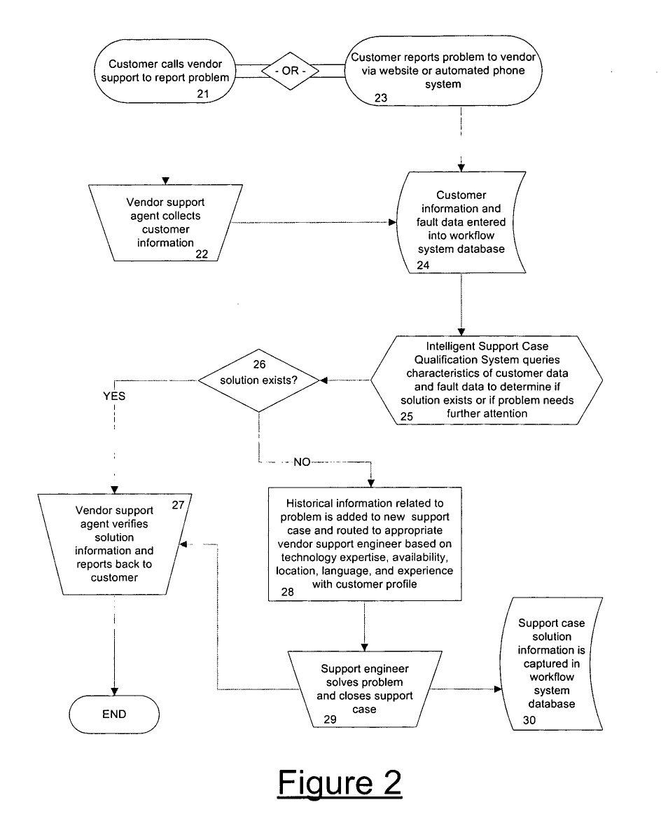

The exemplary databases are used by the system to identify a support engineer who has the required skills to handle a particular service request and is also available to process the request in a timely manner. A flow chart illustrating a method of operation of a system in accordance with the present invention is shown in FIG. 2. The process can be initiated when a customer contacts vendor support with a problem. In the exemplary embodiment illustrated in FIG. 2, the initial contact comprises a customer contacting a support agent (step 21), who then collects the appropriate information regarding the problem (step 22). Alternatively, the customer can access a webpage and enter the appropriate information or an automated phone system could be used to allow for entry of the appropriate information (step 23). Other forms of access could also be employed (e.g., speaking in person to a representative at a service desk).

The information regarding the problem can be supplied to the case management system, either manually entered by the agent or electronically transferred from the website or phone system (step 24) to create a service request. Once entered into the system, a determination can be made as to whether a solution to the service request currently exists within the system. This can be accomplished by identifying characteristics within the service request and comparing the identified characteristics with those of prior service requests stored within the system (step 25). For example, keywords indicating the type of problem could reveal a similarity to a prior request or characteristics of customer data (e.g., operating system, software version) could indicate a particular solution already stored in system.

Based on the comparison of the service request to prior stored requests, a determination can be made whether a solution exists at this point (step 26). If a solution to the service request exists, the solution can be provided to the support agent for verification. Typically, this involves a review of the solution by the support agent to ensure that the information appears to address the customer's concern (step 27). Once approved, the solution can be provided to the customer.

If no solution exists in the database of stored solutions, the service requests can be assigned to a support engineer (step 28). The assigning process can be performed based upon a number of predetermined criteria. For example, each profile can be maintained for each support engineer in the system. The profile can include items such as availability, technological expertise, language proficiency, location, and experience with the characteristics of a particular customer profile. The support case management system 11 can be configured to view the various factors according to a predetermined hierarchy set by the system administrator for any given time. For example, language proficiency might be given a high weight in situations where the support network is worldwide, thus increasing the likelihood that the customers will speak various languages, or in situations where the customer profile indicates that they do not speak English. Alternatively, if the system being supported in a local system that typically incurs a high volume of requests of a relatively simple technological nature, higher priority could be assigned to availability. Additionally, the hierarchy can change over time. For example, during business hours there could be a large number of engineers available, so technical expertise might be factored in more heavily than availability. However, outside of business hours the pool of engineers might be significantly less, so availability could be factored in heavily to avoid extended waiting time.

In an exemplary embodiment, the determination of the appropriate support engineer can be used to narrow the pool of potential engineers by reviewing each factor in the predetermined order. For example, a support request might indicate that a support engineer who is proficient in Java is desired. The pool of support engineers would then be narrowed to only those who meet this criteria. Next, the system might be configured to view availability as the secondary factor behind technical expertise. Thus, the system might again narrow the remaining pool of prospective support engineers (those identified in the first narrowing step) to those who have less than a certain number of cases in the waiting queue associated with each engineer. Any number of factors can be used sequentially to narrow the pool of support engineers until one engineer remains. If, after all of the predetermined factors have been evaluated, there are still more than one support engineer remaining (i.e., more than one engineer is equally qualified to handle the request based on all factors), the system can be configured to assign the request to the qualified engineer with the least number of pending requests, or if everything is equal, the system can randomly select the support engineer. This particular method of selecting an engineer is one of many possible examples. Many alternative weighting and scoring algorithms could also be used in the system described herein.

Once a support engineer is assigned, the information regarding the service request can be provided to the engineer. The engineer processes the request (i.e., determines a solution) in accordance with the protocol established to handle service requests (step 29). Once a solution has been determined, the service request and solution can be stored in the database of prior service requests (step 30). In this manner, the newly determined solution can be available as a resource to the system for reference when managing future service requests.

Additionally, if the customer placing the request does not have a profile stored within the customer profiles database, the support engineer can gather the information necessary to add the customer to the database. In all likelihood, such information has already been obtained in the course of handling the service request, so it can simply be stored to the customer profiles database upon completion of the solving of the support request.

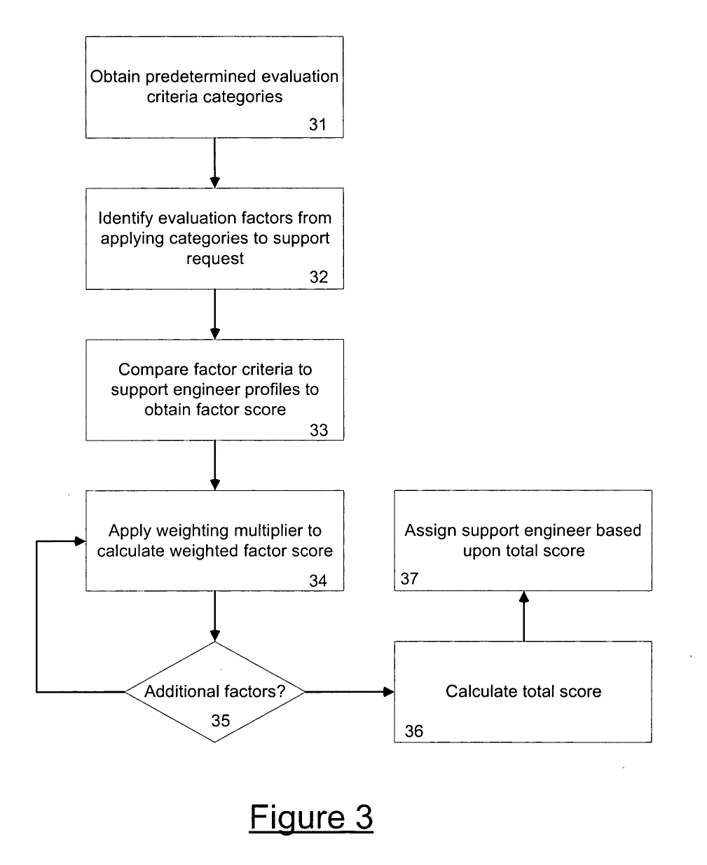

FIG. 3 illustrates the steps involved in an exemplary method of assigning the support engineer once a determination has been made that no solution exists in the system and an engineer is required. In order to assign the appropriate engineer, a predetermined set of criteria can be evaluated to provide the optimal engineer for a particular request. The criteria categories to be evaluated can be read from a database (step 31). In the exemplary embodiment, the criteria can consist of a plurality of factors such as expertise, language, workload, familiarity with customer profile, prior experience with similar requests (based upon keyword searching). Evaluation factors can be determined by applying the categories to the support request (step 32). For example, a category could be customer language. The support request might indicate that the customer desires English communication, so the value for the language evaluation factor might be set to English.

Once evaluation factors have been established for a support request, each factor can be compared to the various support engineers to provide a score for that factor (step 33). The comparison can be made using a mathematical scoring system. For example, each factor can be scored on a scale, for example, a scale of +5 to −5. For example, the first criteria could be language. An indication that a support engineer is fluent in the language of the requester (i.e., language factor) might cause a score of +5 to be given to that particular engineer for that factor. For example, in the support engineer profile, each engineer could have scores for all languages that he or she is fluent in, which could be assigned +5 scores, or can converse in, which might be assigned +3 scores. Additionally, all other languages that the engineer does not understand might be assigned a negative score (i.e., −5).

Additionally, each factor can be assigned a weight according to a predetermined level of importance (step 34). Because it is typically critical for the engineer to communicate with the customer, language could be given a high weight (e.g., 10). The weight can be used as a multiplier to apply to the numerical score for a particular category (step 34), and in this fashion, the key criteria can have more influence on the final score to be used in the assignment process.

Once a weighted score for a criteria is calculated, a determination can be made to see if additional criteria are to be evaluated before selecting a support engineer (step 35). If additional criteria exist upon which the selection can be based, the scoring process can be repeated for each remaining factor. For example, the next criteria to be evaluated could be the expertise of the support engineers. As with languages, the profile for each engineer can store the areas in which he or she has greater proficiency (e.g., in a support system for an accounting software product, areas of expertise could include print modules, reporting modules, graphical issues, etc.). Each area can be assigned a score, which can then be multiplied by a weighting factor for the expertise criteria. For example, expertise could be assigned a weighting factor of 8 indicating it is of high importance, but less so than language proficiency.

Availability, experience with similar cases, as well as other criteria predetermined by the system administrator can be evaluated in the same manner until all predetermined criteria have been scored. Once all of the criteria have been scored, a total score can be obtained for each engineer based by summing the various scores for each criteria (step 36). A support engineer can then be assigned based upon the total score, for example, by selecting the engineer with the highest total score as being the most appropriate for this particular support request (step 37).

In the exemplary embodiment, the solution derived by the support engineer is typically returned to a vendor support agent. The vendor support agent verifies the solution. This provides an additional level of quality control. The vendor support agent returns the solution to the customer in an appropriate manner. In some instances, the service request will be handled while the customer waits (e.g., the customer might remain on hold on his or her telephone for the next available engineer), but often the solution will be provided via a return phone call or via electronic delivery (e.g., email, text message). Alternative embodiments do not utilize a vender support agent (e.g., where support requests are submitted via a web page). In such cases, the solution can be returned via the case management system directly from the support engineer to the customer.

The system described herein in accordance with an exemplary embodiment of the present invention would allow for support requests to be handled in a faster, more efficient manner. It would allow for difficult requests to be routed to those engineers with the proper technological skills, and would efficiently route requests to available engineers to reduce delay in responding to the customer.

A variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

What is claimed is:

1. A method for assigning support in a customer support system comprising:
receiving a support request;
identifying evaluation criteria corresponding to said request based upon a predetermined set of criteria types;
comparing said evaluation criteria with support profiles of a plurality of support engineers;
identifying a selected support engineer based upon the results of said comparison; and
assigning said request to said selected support engineer.

2. The method as set forth in claim 1, further comprising:
comparing said identified evaluation criteria to corresponding criteria for a set of stored solutions prior to comparing said evaluation criteria with said support profiles of said support engineers;
determining if a solution exists in a solution database;
if said solution exists:
verifying said solution; and
reporting said solution.

3. The method as set forth in claim 1, wherein said evaluation criteria comprises at least one of language, availability, expertise or experience.

4. The method as set forth in claim 1, wherein said evaluation criteria are scored according to a predetermined hierarchy.

5. The method as set forth in claim 1, wherein said comparing step comprises assigning a criteria score to each classification criteria and calculating a total score from said criteria scores of each classification.

6. The method as set forth in claim 5, wherein said identifying a selected support engineer step comprises selecting a support engineer based on said total score.

7. The method as set forth in claim 6, wherein a weighting factor is applied to each criteria score based upon a predetermined level of importance prior to calculating said total score.

8. The method as set forth in claim 1, wherein said receiving step comprises receiving information from a customer via a telephone connection to a support agent.

9. The method as set forth in claim 1, wherein said receiving step comprises receiving information from a customer is via a web portal.

10. The method as set forth in claim 1, wherein said receiving step comprises receiving information from a customer via an automated phone system.

11. A system for assigning support in a customer support system comprising:
a support request received from a requester; and
a plurality of databases containing information about a set of support engineers;
wherein said support request is compared with said information and a support engineer is selected based upon the results of said comparison.

12. The system as set forth in claim 11, wherein said plurality of databases comprises a historical database, support engineer profiles database, and a customer profiles database.

13. The system as set forth in claim 11, further comprising a graphical user interface for providing system access.

14. A computer program product comprising a computer useable medium having program logic stored thereon, wherein said program logic comprises machine readable code executable by a computer, wherein said machine readable code comprises instructions for:
receiving a support request;
identifying evaluation criteria corresponding to said request based upon a predetermined set of criteria types;
comparing said evaluation criteria with support profiles of a plurality of support engineers;
identifying a selected support engineer based upon the results of said comparison; and
assigning said request to said selected support engineer.

15. The computer program product as set forth in claim 14, further comprising instructions for:
comparing said identified evaluation criteria to corresponding criteria for a set of stored solutions prior to comparing said evaluation criteria with said support profiles of said support engineers;
determining if a solution exists in a solution database;
if said solution exists:
verifying said solution; and
reporting said solution to said customer.

16. The computer program product as set forth in claim 14, wherein said evaluation criteria comprises at least one of language, availability, expertise or experience.

17. The computer program product as set forth in claim 14, wherein said evaluation criteria are scored according to a predetermined hierarchy.

18. The computer program product as set forth in claim 14, wherein said instruction for said comparing step comprises instructions for assigning a criteria score to each classification criteria and instructions for calculating a total score from said criteria scores of each classification.

19. The computer program product as set forth in claim 18, wherein said instructions for identifying a selected support engineer step comprises instructions for selecting a support engineer based on said total score.

20. The computer program product as set forth in claim 19, further comprising instructions for applying a weighting factor to each criteria score based upon a predetermined level of importance prior to calculating said total score.
